(19) United States
(12) Patent Application Publication
(10) Pub. No.: US 2026/0342795 A1
(43) Pub. Date: Oct. 29, 2026

(54) METHOD AND SYSTEM FOR MANAGING SECURITY CREDENTIALS

(71) Applicant: HUSH SECURITY LTD., Herzliya (IL)

(72) Inventors: Shmulik LADKANI, Tel Aviv (IL); Micha Arye RAVE, Herzliya (IL); Alon HOROWITZ, Tel Aviv (IL); Chen NISNKORN, Kfar Saba (IL)

(21) Appl. No.: 19/550,732

(22) Filed: Feb. 26, 2026

Related U.S. Application Data
(60) Provisional application No. 63/766,404, filed on Mar. 4, 2025.

(51) Int. Cl. H04L 9/40

(52) U.S. Cl. CPC H04L 63/101; H04L 63/0281

(57) ABSTRACT

A method and system for managing security credentials in network communications are disclosed. The method includes monitoring a communication session between a client computing device and at least one server computing device. A kernel-level program on the client computing device intercepts a system or library call pertaining to an outgoing service access request. A Non-Human Identity (NHI) security credential, representing permission of access, may be obtained and injected into the original service access request in real time. The injection may involve inserting the NHI security credential directly into the intercepted call or redirecting the request to a network proxy server for credential insertion. The invention provides efficient, secure, and transparent management of security credentials, potentially reducing network traffic and simplifying maintenance procedures.

### CROSS-REFERENCE TO RELATED APPLICATIONS

This application claims the benefit of priority of U.S. Patent Application No. 63/766,404, filed Mar.4, 2025, which is hereby incorporated by reference in its entirety.

### FIELD OF THE INVENTION

The present invention relates generally to communication networks. More specifically, the present invention relates to a method and system for managing security credentials.

### BACKGROUND OF THE INVENTION

In recent years, the rapid expansion of digital services and cloud-based applications has led to an increasing need for robust and efficient management of security credentials. As organizations adopt more complex and distributed systems, the challenge of securely authenticating and authorizing access to various resources has become paramount. This trend has been particularly evident in the surge of Non-Human Identity (NHI) credentials, which are used, for example, to authenticate machine-to-machine communications, automated processes, Internet of Things (IoT) devices, and the like.

The proliferation of NHI credentials has introduced new challenges in credential management. Traditional methods of managing human user credentials, such as password policies and multi-factor authentication, are often inadequate for handling the scale and complexity of NHI interactions. As a result, organizations have been seeking more sophisticated solutions to manage, rotate, and secure these machine identities effectively.

The need for improved security credential management is driven by several factors. First, the sheer volume of NHI credentials in use has grown exponentially, making manual management increasingly impractical. Second, the potential security risks associated with compromised or misused NHI credentials are significant, as these identities often have broad access to critical systems and data. Third, regulatory compliance requirements have become more stringent, mandating better control and auditing of all types of access credentials, including NHIs.

In response to these challenges, various approaches have been developed to enhance the management of security credentials, particularly for NHI use cases. Currently available systems may employ proxy servers to regulate access to application servers, with some implementations injecting Non-Human Identity (NHI) credentials into service access requests. However, these approaches may present several limitations.

For example, currently available methods may necessitate modifications to applications and workloads on client devices, potentially resulting in complex and challenging maintenance procedures. This is because client workloads may need to be reconfigured individually to support such redirection, which can be time-consuming and error prone. Additionally, these approaches may contribute to increased network traffic and congestion. This is because they may require transferring the entire service communication to be rerouted via the proxy server, potentially leading to bottlenecks and increased latency.

### SUMMARY OF THE INVENTION

As elaborated herein, embodiments of the present invention may utilize a novel approach based on intercepting and processing service access requests using a kernel-level program, to overcome the abovementioned challenges. Embodiments of the present invention may offer improved efficiency in aspects of system maintenance and scaling, as well as network communication, and may also be substantially transparent to the user.

The kernel-level interception may allow for faster, independent processing of requests, as it operates at a lower level of the system stack, potentially reducing overhead and improving response times. In some embodiments, the invention may involve local (e.g., within the client) injection of up-to-date credentials into a service access request, to be handled by an application server.

Additionally, or alternatively, embodiments of the invention may involve steering or redirecting service access requests to at least one dedicated proxy server for the purpose of injecting the up-to-date credentials. This approach may provide several advantages:

Reduced network traffic: By transmitting only the amended service access requests via the proxy server, rather than the entire application service communication, embodiments of the invention may significantly reduce network traffic. This is because only the credential-related information needs to be processed by the proxy, while the bulk of the data can flow directly between the client and the application server. For example, in a scenario where a client device is accessing a large dataset from an application server, only the access request itself may be routed through the proxy server, while the actual data transfer may occur directly between the client and the application server.

Centralized maintenance: The system may allow for easier, centralized maintenance, as updates to access privileges may be implemented primarily on the proxy server. This approach may eliminate the need for frequent updates to individual client devices. This is advantageous because it centralizes the point of control, reducing the complexity of managing multiple client configurations. For instance, when access policies change, administrators may only need to update the proxy server, which can then apply these changes to all subsequent access requests, regardless of the client device's configuration.

Enhanced security through ephemeral credentials: The invention may facilitate the use of short-lived, on-demand credentials, potentially rendering long-term credentials obsolete. This approach may substantially enhance security by reducing the window of opportunity for credential misuse. This is because ephemeral credentials are typically valid for a very short period, minimizing the risk if they are intercepted. For example, instead of using a static API key that remains valid for months, the system may generate a unique, time-limited token for each service access request, which expires shortly after use.

Improved identity attestation: The system may provide a single point of attestation for a client's identity, which may further enhance network security. This centralized approach to identity verification may reduce the risk of impersonation attacks and may simplify auditing processes. This is beneficial because it creates a consistent and reliable method for verifying client identities across the network. For instance, all access attempts may be logged and verified at the proxy server, providing a comprehensive audit trail and allowing for easier detection of unusual access patterns.

Transparency and efficiency: By operating at the kernel level, the invention may intercept and process service access requests more efficiently than user-space solutions. This approach may be substantially transparent to the user and may not require modifications to existing applications. This is advantageous because it allows for seamless integration with existing systems without disrupting user workflows. For example, a web application making API calls to a remote server may continue to function without any changes, while the kernel-level program transparently manages the security credentials.

In summary, embodiments of the present invention may provide a practical application, manifested as an improvement of computer network communications technology, enabling a more efficient, secure, and manageable approach to handling service access requests over these networks.

By leveraging kernel-level interception and dedicated proxy servers for credential injection, Embodiments of the system may offer significant improvements in traffic reduction, maintenance simplification, security enhancement, and operational transparency. These improvements may lead to more robust and scalable network architectures, potentially reducing operational costs and enhancing overall system performance.

Embodiments of the present invention provide a method and system for managing security credentials in network communications. The method may include monitoring a communication session between a client computing device and at least one server computing device. A kernel-level program on the client computing device may be employed to intercept a system or library call based on the monitoring, where the system or library call pertains to an outgoing, original service access request directed to the at least one server computing device.

The method may further involve obtaining a Non-Human Identity (NHI) security credential, which represents a permission of access of the client computing device to the service. The determined NHI security credential may then be injected into the original service access request in real time, in accordance with the permission of access.

In some embodiments, the injecting may comprise inserting the NHI security credential into the intercepted call, to produce an updated service access request. The updated service access request may then be transmitted to the server computing device, in accordance with the permission of access.

Alternatively, the injecting may involve redirecting the original service access request, by the kernel-level program, to a network proxy server. The network proxy server may insert the NHI security credential into the original service access request, to produce an updated service access request. The network proxy server may then transmit the updated service access request to the server computing device, in accordance with the permission of access.

In some cases, the original service access request may comprise an initial NHI security credential. The injecting may then involve replacing the initial NHI security credential with the obtained NHI security credential, to produce the updated service access request.

The NHI security credential may dictate denial of access to the service in some instances. In such cases, the method may include avoiding transmission of the service access request to the server computing device, and communicating indication of denial of access to at least one computing device. This computing device may be selected from the client computing device, the server computing device, a computing device associated with an administrator of the client computing device, and a computing device associated with an administrator of the server computing device.

The NHI security credential may be selected from various types, including but not limited to an Application Programming Interface (API) token, an API encryption key, and a password.

The method may also involve maintaining a policy data structure on an Identity and Access Management (IAM) server. This policy data structure may associate specific identifiers (such as server computing device identifiers, service identifiers, application identifiers and client computing device identifiers) with respective access permissions.

In some embodiments, the method may include updating the client computing device regarding its respective access permissions, as associated by the policy data structure. The NHI security credential may then be generated by a processor of the client computing device, to reflect access permission of the client computing device to the service, in accordance with the policy data structure.

Alternatively, the method may involve updating the network proxy server regarding access permissions of the client computing device, as associated by the policy data structure. The NHI security credential may then be generated by a processor of the network proxy server, to reflect access permission of the client computing device to the service, in accordance with the policy data structure.

Embodiments of the present invention may include a system for managing security credentials by a client computing device. The client computing device may comprise a non-transitory memory device storing modules of instruction code, and at least one processor configured to execute these modules. Upon execution, the processor may monitor a communication session between the client computing device and at least one server computing device, employ a kernel-level program to intercept a system or library call pertaining to an outgoing, original service access request, and redirect the original service access request to a network proxy server. The network proxy server may be configured to obtain an NHI security credential representing a permission of access, inject the obtained NHI security credential into the original service access request to produce an updated service access request, and transmit the updated service access request to the server computing device.

In some embodiments, the invention may include a network proxy server for managing security credentials. The proxy server may comprise a non-transitory memory device storing modules of instruction code, and at least one processor configured to execute these modules. Upon execution, the processor may receive a redirected service access request from a client computing device, where the redirected request is an original request intercepted by a kernel-level program on the client device. The processor may then obtain an NHI security credential representing a permission of access, inject the obtained NHI security credential into the redirected service access request to produce an updated service access request, and transmit the updated service access request to at least one server computing device, in accordance with the permission of access.

These embodiments of the invention provide a comprehensive approach to managing security credentials, offering flexibility in implementation and enhancing security in network communications.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for managing security credentials according to some embodiments of the invention; and

FIG. 2 is a block diagram, depicting a system for managing security credentials, according to some embodiments of the invention;

FIG. 3 is a sequence diagram illustrating flow of communication between components of a system for managing security credentials according to some embodiments of the invention; and

FIG. 4 is a flow diagram, depicting a method of managing security credentials, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer’s registers and/or memories into other data similarly represented as physical quantities within the computer’s registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

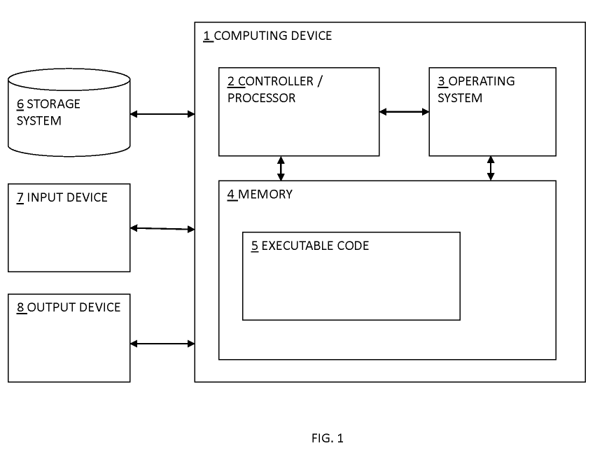

Reference is now made to FIG. 1, which is a block diagram depicting a computing device, which may be included within an embodiment of a system for managing security credentials, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one like executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may manage security credentials as further described herein. Although, for the sake of clarity, a single item of executable code 5 is shown in FIG. 1, a system according to some embodiments of the invention may include a plurality of executable code segments like executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Data pertaining to security credentials may be stored in storage system 6, and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., like element 2), a plurality of input units, a plurality of output units, a plurality of memory units, and a plurality of storage units.

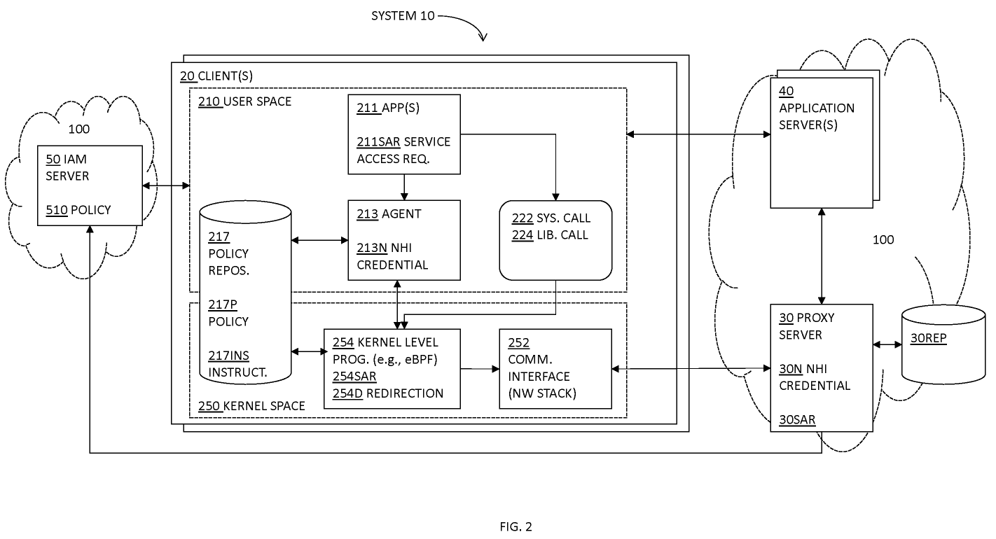

Reference is now made to FIG. 2, which is a block diagram, depicting a system 10 for managing security credentials, according to some embodiments of the invention.

According to some embodiments of the invention, system 10 may be implemented as a software module, a hardware module, or any combination thereof. For example, system may be or may include a computing device such as element 1 of FIG. 1, and may be adapted to execute one or more modules of executable code (e.g., element 5 of FIG. 1) to manage security credentials, as elaborated herein.

As shown in FIG. 2, arrows may represent flow of one or more data elements to and from system 10 and/or among modules or elements of system 10. Some arrows have been omitted from FIG. 2 for the purpose of clarity.

FIG. 2 illustrates components involved in managing security credentials between a client computing device 20, and an application server 40. As described herein, system 10 may leverage kernel-level programmability and user-space management to enforce security policies and manage credentials dynamically, without requiring modifications to the original application code. It may be appreciated by a person skilled in the art that this approach may enhance communication security between client computing device 20 and application server 40, while maintaining minimal performance overhead.

As known in the art, client computing device 20 may operate on two, complementary levels of its operating system, commonly referred to as the user space 210 and kernel space 250.

In user space 210, applications 211 may communicate with at least one server computing device, denoted herein as “application server” 40 via a communication network 100 (e.g., a cellular network, the Internet, and the like). Applications 211 may generate one or more service access requests 211SAR, intended to obtain access to one or more services and/or data elements on application server 40.

In the kernel space, client 20 may continuously monitor the communication session between client 20 and server 40. As explained herein, client 20 may employ at least one kernel-level program 254 in the kernel space 250, to intercept a system call 222 or library call 224 that pertains to outgoing service access requests 211SAR, based on the monitored communication.

The service access requests 211SAR may subsequently be redirected, and/or modified, to manage Non-Human Identity (NHI) credentials 213N, according to predetermined permissions, as elaborated herein. Embodiments of the invention may thereby control interaction of client computing device 20 with one or more services or applications of server 40.

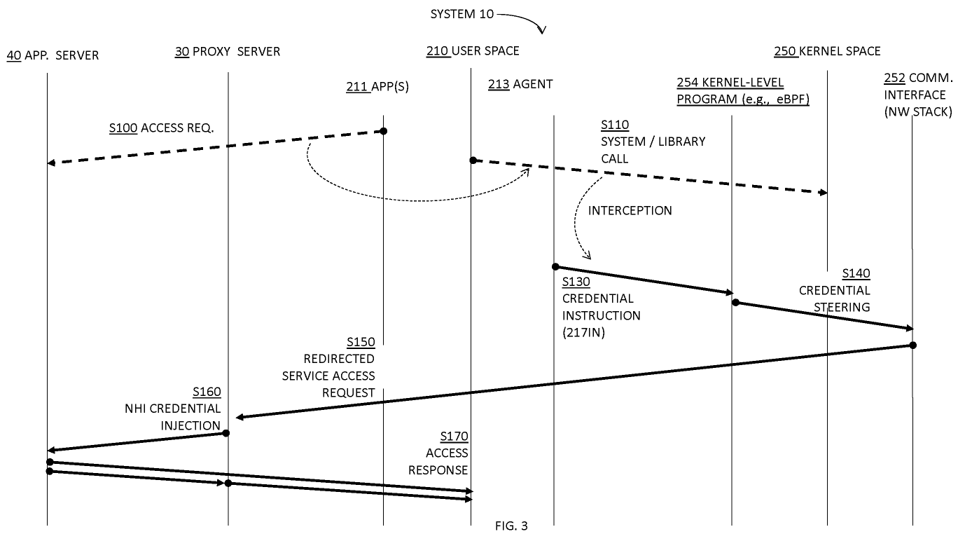

Reference is also made to FIG. 3, which is a sequence diagram illustrating flow of communication between components of system 10 (which may be the same as system 10 of FIG. 2), for managing security credentials according to some embodiments of the invention.

As shown in FIG. 3, an application 211 within user space 210 may initiate an access request S100, which may be the same as service access requests 211SAR of FIG. 2, and may be directed towards application server 40 via communication network 100. Access request S100 may be intercepted by a kernel-level program 254. The term “intercepted” may be used in this context to indicate that access request S100 may not be transmitted through network 100 (and is therefore marked by a dashed arrow), but rather be halted, to be modified and/or redirected as elaborated herein.

Kernel-level program 254 may include one or more processes or threads, may be executed by a processor (e.g., processor 2 of FIG. 1), and may have kernel-level privileges. For example, kernel-level program 254 may be, or may include an extended Berkeley Packet Filter (eBPF) program 254, which may operate at least partially within kernel space 250, as known in the art.

According to some embodiments, kernel-level program 254 may intercept access request S100 at a point of a system or library call S110, which may be the same as system 222 and library 224 calls of FIG. 2. Kernel-level program 254 may thus monitor and control the outgoing service access request S100.

According to some embodiments, one or more (e.g., each) client computing device 20 may include at least one program or process, denoted herein as agent 213. Agent 213 may reside within a user space 210 of client 20, and may possess user-level privileges, as known in the art.

Additionally, one or more (e.g., each) client computing device 20 may include, or may be associated with a respective policy repository 217, which may be accessible to both agent 213 and kernel-level program 254.

According to some embodiments, agent 213 may populate, or maintain one or more access policy data elements 217P within policy repository 217. Access policy data elements 217P may define accessibility of client computing device 20 to various other computing devices and/or stored data. For example, Access policy data elements 217P may include one or more Non-Human Identity (NHI) security credentials, that may facilitate access of programs or workloads that are executed on client 20 to online services that are provided by servers 40, as known in the art.

Additionally, or alternatively, agent 213 may populate, or maintain one or more credential instructions 217INS within policy repository 217. Credential instructions 217INS may correspond to respective access policy data elements 217P, and may dictate specific actions or operations to be performed following interception of service access requests 211SAR. For example, credential instructions 217INS may include a redirection instruction, dictating redirection of the service access requests 211SAR to a substitute target (e.g., a substitute Internet Protocol (IP) address), as elaborated herein.

Agent 213 may continuously update policy repository 217, e.g., periodically, or in response to a triggering event. Policy repository 217 may thus maintain an up-to-date snapshot of client 20’s access capabilities, as dictated by access policy data elements 217P, and/or credential instructions 217INS.

Upon interception of access request S100 (e.g., system call or library call S110), kernel-level program 254 may read credential instruction S130 (denoted 217INS in FIG. 2) and/or access policy data elements 217P from policy repository 217.

Credential instruction S130 (217INS) may guide kernel-level program (e.g., eBPF program) 254 on handling the intercepted data access request S100.

For example, credential instruction S130 may direct system 10 to obtain a NHI security credential (denoted 213N and/or 30N in FIG. 2), which may represent a permission of access of client computing device 20 to server 40 (e.g., a service of server 40). System 10 may subsequently inject the determined NHI security credential 213N/30N into the service access request 211SAR, in accordance with the permission of access, as explained herein.

Server 40 may thus receive an updated version of service access request 211SAR in real time or near-real time. The terms “real-time” and “near-real time” may be used in this context to indicate that server 40 may allow access to one or more services and/or data elements substantially immediately after client 20 has initiated service access request 211SAR, within a timeframe that is time-wise acceptable for applications 211. Alternatively, the terms “real-time” and “near-real time” may be used to indicate a streamlined process, where access credentials are managed on demand, without having to query for credentials in run time, and without having to apply changes in code of applications 211 on client computing devices 20.

It may be appreciated that server 40 may serve a large number (e.g., thousands) of client computing devices 20 at a time. Therefore, embodiments of the invention may provide a practical application by improving the real-time functionality of a communication network, in a manner that is not feasible as a mental process.

Additionally, and as elaborated herein, policy repository 217 may be continuously updated, to maintain an up-to-date snapshot of client 20’s access policy data elements 217P and/or credential instructions 217INS. System 100 may thus support management of short-term, on demand, ephemeral credentials. Embodiments of the invention may therefore render usage of long-term credentials obsolete, further boosting network communication security.

According to some embodiments, credential instruction S130 (also denoted 217INS) may include an instruction for injecting, or inserting an NHI security credential 213N into the intercepted system call 222 or library call 224. Kernel level program 254 may thus inject NHI security credential 213N, to produce an updated service access request 254SAR, that may reflect predefined access permissions of applications 211 on client computing device 20.

Credential instruction S130 may include at least one instruction for redirecting (254D of FIG. 2), or steering S140 service access request 211SAR, e.g., toward a predetermined proxy server computing device 30. Kernel level program (e.g., eBPF program) 254 may thus control a communication interface (e.g., a network stack) 252, to redirect S150 service access request 211SAR via network 100 to proxy server computing device 30, for further processing.

Proxy server 30 may, in turn, communicate with one or more Identity and Access Management (IAM) servers 50, to maintain updated NHI security credential 30N for the one or more (e.g., each) client computing device. Upon reception of the redirected service access request 211SAR, proxy server 30 may inject, or insert S160 the appropriate NHI security credential 30N into the redirected S150 service access request 211SAR, to produce an updated version 30SAR of service access request 211SAR.

For example, original service access request 211SAR may include an initial NHI security credential, and proxy server 30 may inject, or insert S160 the appropriate NHI security credential 30N by replacing the initial NHI security credential with the obtained NHI security credential. Proxy server 30 may thereby produce updated service access request 30SAR.

According to some embodiments, proxy server computing device 30 may subsequently transmit the updated service access request 30SAR to server computing device 40, in accordance with the permission of access.

For example, NHI security credential 30N may indicate denial of access to the requested service. In such embodiments, proxy server computing device 30 may be configured to deny application 211 of client 20 from accessing the service of server 40, by avoiding transferal of updated service access request 30SAR to server 40. Additionally, or alternatively, proxy server computing device 30 may be configured to deny access of application 211 to a service of server 40 by avoiding creation of updated service access request 30SAR altogether.

Proxy server computing device 30 may further communicate indication of the denial of access to at least one other computing device. For example, proxy server computing device 30 may communicate a denial message to client computing device 20, to server computing device 40, to a computing device (such as device 1 of FIG. 1) associated with an administrator of the client computing device 20, to a computing device associated with an administrator of the server computing device 40, and the like.

Additionally, or alternatively, NHI security credential 30N of the updated service access request 30SAR may reflect, or ensure alignment with predefined access permissions of applications 211 on client computing device 20.

For example, NHI security credential 30N may include an Application Programming Interface (API) token, allowing verification of a user or application making the request, ensuring that only authorized entities can access a service on server 40.

In another example, NHI security credential 30N may manage sessions between client 20 and server 40, keeping track of user interactions with the API over time.

In another example, NHI security credential 30N may comply with an expiration time limit, to become invalid, according to a predetermined renewal policy.

In yet another example, NHI security credential 30N may include a password, which may allow access to data that is managed or stored by server 40.

As shown in FIG. 3, application server 40 may send (e.g., via proxy 30, or directly) an access response S170 back to application(s) 211 of client computing device 20, thereby completing the request and response sequence. Access response S170 may confirm successful management and injection of NHI credential 30N, allowing the execution of applications 211 to proceed in accordance with the security policies enforced by system 10.

As shown in FIG. 2, system 10 may include, or may be communicatively connected to an Identity and Access Management (IAM) server 50. As known in the art, IAM server 50 may be adapted to maintain a policy data structure 510. Policy data structure 510 may, for example, include one or more tables that associate between specific identifiers and corresponding access permissions.

For example, policy data structure 510 may associate between (a) server computing device identifiers, identifiers of specific services, identifiers of specific applications, identifiers of client computing devices, and the like, and (b) respective credentials, permissions, levels of authorizations, and the like.

As explained herein, one or more (e.g., each) client computing device 20 may include, or may be associated with a policy repository 217. Client computing device 20 may continuously (e.g., periodically, over time) communicate with IAM server 50, to update repository 217 (and hence client computing device 20 itself) regarding its respective access permissions, as associated by the policy data structure. For example, policy repository 217 may be updated by IAM server 50 regarding new permissions for accessing computing assets and/or services on optionally new servers 40, revocation of such permissions, changes in authorization levels, and the like.

According to some embodiments, processor 2 of client computing device 20 may employ agent 213 to generate NHI security credential 213N, so as to reflect access permissions of client computing device to one or more identified elements (e.g., computing assets and/or services), in accordance with policy data structure 510. As elaborated herein, kernel-level program 254 may subsequently inject NHI security credential 213N, to produce an updated service access request 254SAR, that may reflect updated access permissions of client computing device 20, in accordance with policy repository 217.

Additionally, or alternatively, network proxy server 30 may include, or may be associated with a policy repository 30REP, which may associate between specific identifiers (e.g., server computing device identifiers, identifiers of specific services, identifiers of specific applications, identifiers of specific client computing devices, and the like) and corresponding permissions. Proxy server 30 may continuously (e.g., periodically, over time) communicate with IAM server 50, to update repository 30REP regarding these access permissions (e.g., access permissions of specific client computing devices 20), as dictated by policy data structure 510.

According to some embodiments, a processor (e.g., processor 2 of FIG. 1) of proxy server 30 may generate the NHI security credential 30N, to reflect access permission of the one or more client computing devices 20 to a service of at least one server 40, in accordance with policy data structure 510. As elaborated herein, proxy server 30 may subsequently inject NHI security credential 30N, to produce an updated version 30SAR of service access request 211SAR. Updated version 30SAR may reflect updated access permissions of client computing device 20, in accordance with policy repository 30REP.

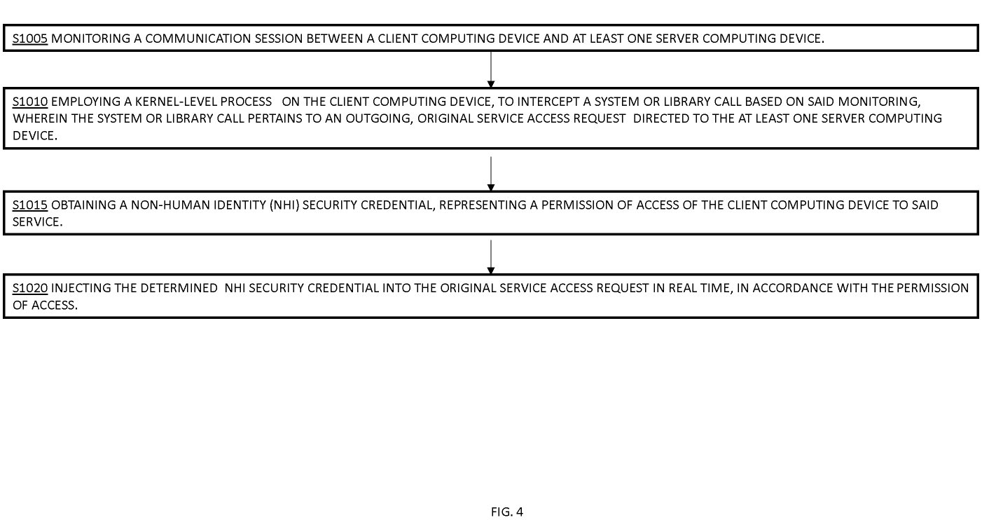

Reference is also made to FIG. 4, which is a flow diagram, depicting a method of managing security credentials by at least one processor (e.g., element 2 of FIG. 1) , according to some embodiments of the invention.

Embodiments of the method may begin at step S1005 with monitoring a communication session between a client computing device 20 and at least one server computing device 40 via a communication network 100. This monitoring may be performed by a processor 2 of the client computing device 20, e.g., by a kernel-level program 254 operating within the kernel space 250 of the client computing device 20. The kernel-level program 254 may continuously observe network traffic passing through the communication interface 252, allowing it to detect and analyze outgoing service access requests.

Following the monitoring, the process may proceed to step S1010, which may involve employing the kernel-level program 254 on the client computing device 20 to intercept a system call 222 or library call 224. This interception is based on the monitoring from step S1005, where the system or library call pertains to an outgoing, original service access request 211SAR directed to the at least one server computing device 40. The kernel-level program 254 may utilize its privileged access within the kernel space 250 to intercept these calls before they reach the network stack, allowing for inspection and potential modification of the request.

The process then moves to step S1015, which involves obtaining a Non-Human Identity (NHI) security credential 213N or 30N. This credential represents a permission of access of the client computing device 20 to the service provided by the server computing device 40. The obtaining of the NHI security credential may be performed in different ways depending on the specific implementation of the system.

In some embodiments, the NHI security credential 213N may be obtained by the agent module 213 within the user space 210 of the client computing device 20. The agent module 213 may access the policy repository 217, which contains access policies 217P and credential instructions 217INS. Based on these policies and instructions, the agent module 213 may generate or retrieve the appropriate NHI security credential 213N.

Additionally, or alternatively, in a proxy-based implementation, the NHI security credential 30N may be obtained by the proxy server 30. In this case, the proxy server 30 may access its own proxy repository 30REP to determine the appropriate credential based on the client's identity and the requested service.

The final step S1020 involves injecting the determined NHI security credential into the original service access request in real time, in accordance with the permission of access. This injection may be performed in different ways depending on the system's configuration.

In a client-based injection scenario, the kernel-level program 254 may insert the NHI security credential 213N directly into the intercepted system or library call, creating an updated access request 254SAR. This updated request is then sent to the server computing device 40 through the communication interface 252 and network 100.

In a proxy-based injection scenario, the kernel-level program 254 may redirect the original service access request to the proxy server 30 using the redirection instruction 254D. The proxy server 30 then injects the NHI security credential 30N into the request, creating a proxy access request 30SAR, which is subsequently sent to the server computing device 40.

Throughout this process, the Identity and Access Management (IAM) server 50 may maintain and update the policy structure 510, which informs the access policies and credential instructions used by client computing device 20 and/or proxy server 30.

This method allows for dynamic, real-time management of security credentials in network communications, enhancing security and efficiency while maintaining transparency to the applications 211 running in the user space 210 of the client computing device 20.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of managing security credentials by at least one processor, the method comprising:
monitoring a communication session between a client computing device and at least one server computing device;
employing a kernel-level program on the client computing device, to intercept a system or library call based on said monitoring, wherein the system or library call pertains to an outgoing, original service access request directed to the at least one server computing device;
obtaining a Non-Human Identity (NHI) security credential, representing a permission of access of the client computing device to said service;
injecting the determined NHI security credential into the original service access request in real time, in accordance with the permission of access.

2. The method of claim 1, wherein said injecting comprises inserting the NHI security credential into the intercepted call, to produce an updated service access request, and wherein the method further comprises transmitting the updated service access request to the server computing device, in accordance with said permission of access.

3. The method of claim 1, wherein said injecting comprises:
redirecting the original service access request, by the kernel-level program, to a network proxy server;
inserting, by the network proxy server, the NHI security credential into the original service access request, to produce an updated service access request; and
transmitting the updated service access request by the network proxy server to the server computing device, in accordance with said permission of access.

4. The method of claim 1, wherein the original service access request comprises an initial NHI security credential, and wherein said injecting comprises replacing the initial NHI security credential with the obtained NHI security credential, to produce the updated service access request.

5. The method of claim 1, wherein the NHI security credential dictates denial of access to said service, and wherein the method further comprises:
avoiding transmission of the service access request to the server computing device; and
communicating indication of denial of access to at least one computing device, selected from the client computing device, the server computing device, a computing device associated with an administrator of the client computing device, and a computing device associated with an administrator of the server computing device.

6. The method of claim 1 wherein the NHI security credential is selected from a list consisting of: an Application Programming Interface (API) token, an API encryption key, a password, and any combination thereof.

7. The method of claim 3, further comprising maintaining a policy data structure on an Identity and Access Management (IAM) server, wherein said policy data structure associates between (a) specific identifiers selected from server computing device identifiers, service identifiers, application identifiers and client computing device identifiers, and (b) respective access permissions.

8. The method of claim 7, further comprising:
updating the client computing device regarding its respective access permissions, as associated by the policy data structure;
generating the NHI security credential by a processor of the client computing device, to reflect access permission of the client computing device to said service, in accordance with the policy data structure.

9. The method of claim 7, further comprising:
updating the network proxy server regarding access permissions of the client computing device, as associated by the policy data structure;
generating the NHI security credential by a processor of the network proxy server, to reflect access permission of the client computing device to said service, in accordance with the policy data structure.

10. A system for managing security credentials by a client computing device, wherein the client computing device comprises a non-transitory memory device, wherein modules of instruction code are stored, and at least one processor associated with the memory device, and configured to execute the modules of instruction code, whereupon execution of said modules of instruction code, the at least one processor is configured to:
monitor a communication session between the client computing device and at least one server computing device;
employ a kernel-level program to intercept a system or library call based on said monitoring, wherein the system or library call pertains to an outgoing, original service access request directed to the at least one server computing device; and
redirect, by the kernel-level program, the original service access request to a network proxy server, wherein the network proxy server is configured to:
obtain an NHI security credential, representing a permission of access of the client computing device to a service;
inject the obtained NHI security credential into the original service access request to produce an updated service access request; and
transmit the updated service access request to the at least one server computing device, in accordance with the permission of access.

11. The system of claim 10, wherein said injecting comprises inserting the NHI security credential into the intercepted call, to produce an updated service access request.

12. The system of claim 10, wherein said injecting comprises redirecting the original service access request, by the kernel-level program, to a network proxy server, wherein the network proxy server is configured to:
insert the NHI security credential into the original service access request, to produce an updated service access request; and
transmit the updated service access request to the server computing device, in accordance with said permission of access.

13. The system of claim 10, wherein the original service access request comprises an initial NHI security credential, and wherein said injecting comprises replacing the initial NHI security credential with the obtained NHI security credential, to produce the updated service access request.

14. The system of claim 10, wherein the NHI security credential dictates denial of access to said service, and wherein the network proxy server is further configured to:
avoid transmission of the service access request to the server computing device; and
communicate indication of denial of access to at least one computing device, selected from the client computing device, the server computing device, a computing device associated with an administrator of the client computing device, and a computing device associated with an administrator of the server computing device.

15. The system of claim 10 wherein the NHI security credential is selected from a list consisting of: an Application Programming Interface (API) token, an API encryption key, a password, and any combination thereof.

16. The system of claim 12, further comprising an Identity and Access Management (IAM) server, adapted to maintain a policy data structure, wherein said policy data structure associates between (a) specific identifiers selected from server computing device identifiers, service identifiers, application identifiers and client computing device identifiers, and (b) respective access permissions.

17. The system of claim 16, wherein the IAM server is further configured to update the client computing device regarding its respective access permissions, as associated by the policy data structure,
and wherein the processor of the client computing device is further configured to generate the NHI security credential, to reflect access permission of the client computing device to said service, in accordance with the policy data structure.

18. A network proxy server for managing security credentials, the proxy server comprising: a non-transitory memory device, wherein modules of instruction code are stored, and at least one processor associated with the memory device, and configured to execute the modules of instruction code, whereupon execution of said modules of instruction code, the at least one processor is configured to:
receive a redirected service access request from a client computing device, wherein the redirected service access request is an original service access request intercepted by a kernel-level program on the client computing device;
obtain an NHI security credential, representing a permission of access of the client computing device to a service;
inject the obtained NHI security credential into the redirected service access request to produce an updated service access request; and
transmit the updated service access request to at least one server computing device, in accordance with the permission of access.
